(19) United States
(12) Patent Application Publication
(10) Pub. No.: US 2022/0130156 A1
(43) Pub. Date: Apr. 28, 2022

(54) THREE-DIMENSIONAL OBJECT DETECTION AND INTELLIGENT DRIVING

(71) Applicant: SHENZHEN SENSETIME TECHNOLOGY CO., LTD., Shenzhen (CN)

(72) Inventors: Shaoshuai SHI, Shenzhen (CN); Chaoxu GUO, Shenzhen (CN); Zhe WANG, Shenzhen (CN); Jianping SHI, Shenzhen (CN); Hongsheng LI, Shenzhen (CN)

(21) Appl. No.: 17/571,887

(22) Filed: Jan. 10, 2022

Related U.S. Application Data
(63) Continuation of application No. PCT/CN2020/129876, filed on Nov. 18, 2020.

(30) Foreign Application Priority Data
Dec. 13, 2019 (CN) 201911285258.X

(51) Int. Cl. G06V 20/64; G06T 7/70; G06V 10/40; G06V 20/70; G06K 9/62; G06V 10/82; G06T 17/00; G06V 10/22

(52) U.S. Cl. CPC G06V 20/64; G06T 7/70; G06V 10/40; G06V 20/70; G06T 2207/20084; G06V 10/82; G06T 17/00; G06V 10/225; G06T 2200/04; G06K 9/6232

(57) ABSTRACT

Methods, apparatuses, devices, and computer-readable storage media for three-dimensional object detection and intelligent driving are provided. In one aspect, a method includes: obtaining voxelized point cloud data corresponding to a plurality of voxels by voxelizing three-dimensional point cloud data; obtaining first feature information of the voxels and one or more initial three-dimensional bounding boxes by performing feature extraction on the voxelized point cloud data; for each of a plurality of key points obtained by sampling the three-dimensional point cloud data, determining second feature information of the key point according to location information of the key point and the first feature information of the plurality of voxels; and determining a target three-dimensional bounding box including a three-dimensional object to be detected from the one or more initial three-dimensional bounding boxes according to the second feature information of the key point located in the one or more initial three-dimensional bounding boxes.

### CROSS REFERENCE TO RELATED APPLICATIONS

The present application is a continuation of International Application No. PCT/CN2020/129876, filed on Nov. 18, 2020, which claims priority of the Chinese patent application No. CN201911285258.X filed on Dec. 13, 2019, all of which are incorporated herein by reference in their entireties.

### TECHNICAL FIELD

The present disclosure relates to computer vision technologies, and in particular to three-dimensional object detection methods, apparatuses and devices and computer readable storage media, and intelligent driving methods, apparatuses and devices and computer readable storage media.

### BACKGROUND

A radar, as one of the most important sensors in three-dimensional object detection, can capture a surrounding scenario structure well by generating a sparse radar point cloud. The three-dimensional object detection based on radar point cloud has important application value in actual application scenarios such as automatic driving and robot navigation.

### SUMMARY

According to an aspect of the present disclosure, there is provided a computer-implemented method. The method includes: obtaining, by voxelizing three-dimensional point cloud data, voxelized point cloud data corresponding to a plurality of voxels; obtaining, by performing feature extraction on the voxelized point cloud data, respective first feature information of the plurality of voxels and one or more initial three-dimensional bounding boxes; for each of a plurality of key points obtained by sampling the three-dimensional point cloud data, determining, according to location information of the key point and the respective first

feature information of the plurality of voxels, second feature information of the key point; and determining, according to the second feature information of the key point located in each of the one or more initial three-dimensional bounding boxes, a target three-dimensional bounding box from the one or more initial three-dimensional bounding boxes, wherein the target three-dimensional bounding box comprises a three-dimensional object to be detected.

In combination with any embodiment of the present disclosure, where obtaining, by performing feature extraction on the voxelized point cloud data, the respective first feature information of the plurality of voxels includes: performing a three-dimensional convolutional operation for the voxelized point cloud data with a pre-trained three-dimensional convolutional network, wherein the pre-trained three-dimensional convolutional network comprises a plurality of convolutional blocks connected sequentially and each of the plurality of convolutional blocks is configured to perform a corresponding three-dimensional convolutional operation for input data; obtaining a respective three-dimensional semantic feature volume output by each of the plurality of convolutional blocks, wherein each of the respective three-dimensional semantic feature volumes comprises a three-dimensional semantic feature of each of the plurality of voxels; and for each of the plurality of voxels, obtaining, according to the respective three-dimensional semantic feature volume output by each of the plurality of convolutional blocks, the first feature information of the voxel.

In combination with any embodiment of the present disclosure, where obtaining the one or more initial three-dimensional bounding boxes includes: obtaining third feature information of each pixel in a top-view feature map that is obtained by projecting, at a top-view angle, the respective three-dimensional semantic feature volume output by a last convolutional block in the pre-trained three-dimensional convolutional network; setting one or more three-dimensional anchor boxes with the each pixel as a center; for each of the one or more three-dimensional anchor boxes, determining, according to the third feature information of one or more pixels located on a border of the three-dimensional anchor box, a confidence score of the three-dimensional anchor box; and determining, according to the confidence score of each of the three-dimensional anchor boxes, the one or more initial three-dimensional bounding boxes from the one or more three-dimensional anchor boxes.

In combination with any embodiment of the present disclosure, where the plurality of convolutional blocks in the pre-trained three-dimensional convolutional network are configured to output three-dimensional semantic feature volumes of different scales, and where determining, according to the location information of the key point and the respective first feature information of the plurality of voxels, the second feature information of the key point comprises: converting the respective three-dimensional semantic feature volume output by each of the plurality of convolutional blocks and the key point into a coordinate system; in the coordinate system, for each of the plurality of convolutional blocks, determining, according to the respective three-dimensional semantic feature volume output by the convolutional block, a three-dimensional semantic feature of a non-empty voxel of the key point in at least one of first set ranges, and determining, according to the three-dimensional semantic feature of the non-empty voxel, a first semantic feature vector of the key point in the convolutional block; obtaining, by sequentially connecting the first semantic feature vectors of the key point in the plurality of convolutional blocks, a second semantic feature vector of the key point; and taking the second semantic feature vector of the key point as the second feature information of the key point.

In combination with any embodiment of the present disclosure, where, for each of the plurality of convolutional blocks, determining, according to the respective three-dimensional semantic feature volume output by the convolutional block, the three-dimensional semantic feature of the non-empty voxel of the key point in the at least one of the first set ranges includes: determining, according to the respective three-dimensional semantic feature volume output by the convolutional block, the three-dimensional semantic feature of the non-empty voxel of the key point in each of the first set ranges, and where determining, according to the three-dimensional semantic feature of the non-empty voxel, the first semantic feature vector of the key point in the convolutional block includes: for each of the first set ranges, determining, according to the three-dimensional semantic feature of the non-empty voxel of the key point in the first set range, an initial first semantic feature vector of the key point corresponding to the first set range; and obtaining, by performing weighted averaging on the initial first semantic feature vectors of the key point corresponding to the first set ranges, the first semantic feature vector of the key point in the convolutional block.

In combination with any embodiment of the present disclosure, where the plurality of convolutional blocks in the pre-trained three-dimensional convolutional network are configured to output three-dimensional semantic feature volumes of different scales, and where determining, according to the location information of the key point and the respective first feature information of the plurality of voxels, the second feature information of the key point includes: converting the respective three-dimensional semantic feature volume output by each of the plurality of convolutional blocks and the key point into a coordinate system; in the coordinate system, for each of the plurality of convolutional blocks, determining, according to the respective three-dimensional semantic feature volume output by the convolutional block, a three-dimensional semantic feature of a non-empty voxel of the key point in a first set range, and determining, according to the three-dimensional semantic feature of the non-empty voxel, a first semantic feature vector of the key point in the convolutional block; obtaining, by sequentially connecting the first semantic feature vectors of the key point in the plurality of convolutional blocks, a second semantic feature vector of the key point; obtaining a point cloud feature vector of the key point in the three-dimensional point cloud data; obtaining, by projecting the key point to a top-view feature map, a top-view feature vector of the key point, wherein the top-view feature map is obtained by projecting the respective three-dimensional semantic feature volume output by a last convolutional block in the pre-trained three-dimensional convolutional network at a top-view angle; obtaining a target feature vector of the key point by connecting the second semantic feature vector, the point cloud feature vector, and the top-view feature vector of the key point; and taking the target feature vector of the key point as the second feature information of the key point.

In combination with any embodiment of the present disclosure, where the plurality of convolutional blocks in the pre-trained three-dimensional convolutional network are configured to output three-dimensional semantic feature volumes of different scales, and where determining, according to the location information of the key point and the respective first feature information of the plurality of voxels, the second feature information of the key point includes: converting the respective three-dimensional semantic feature volume output by each of the plurality of convolutional blocks and the key point into a coordinate system; in the coordinate system, for each of the plurality of convolutional blocks, determining, according to the three-dimensional semantic feature volume output by the convolutional block, a three-dimensional semantic feature of a non-empty voxel of the key point in a first set range, and determining, according to the three-dimensional semantic feature of the non-empty voxel, a first semantic feature vector of the key point in the convolutional block; obtaining, by sequentially connecting the first semantic feature vectors of the key point in the plurality of convolutional blocks, a second semantic feature vector of the key point; obtaining a point cloud feature vector of the key point in the three-dimensional point cloud data; obtaining, by projecting the key point to a top-view feature map, a top-view feature vector of the key point, wherein the top-view feature map is obtained by projecting the respective three-dimensional semantic feature volume output by a last convolutional block in the three-dimensional convolutional network at a top-view angle; obtaining a target feature vector of the key point by connecting the second semantic feature vector, the point cloud feature vector, and the top-view feature vector of the key point; predicting a probability that the key point is a foreground point; obtaining, by multiplying the probability that the key point is a foreground point by the target feature vector of the key point, a weighted feature vector of the key point; and taking the weighted feature vector of the key point as the second feature information of the key point.

In combination with any embodiment of the present disclosure, where obtaining the plurality of key points by sampling the three-dimensional point cloud data includes: obtaining the plurality of key points by sampling the three-dimensional point cloud data based on farthest point sampling.

In combination with any embodiment of the present disclosure, wherein determining, according to the second feature information of the key point located in each of the one or more initial three-dimensional bounding boxes, the target three-dimensional bounding box from the one or more initial three-dimensional bounding boxes includes: for each of the one or more initial three-dimensional bounding boxes, determining a plurality of sampling points according to grid points that are obtained by gridding the initial three-dimensional bounding box; for each of the plurality of sampling points, obtaining a corresponding key point in at least one of second set ranges of the sampling point, and determining respective fourth feature information of the sampling point according to the second feature information of the respective key point in the at least one of the second set ranges of the sampling point; obtaining, by sequentially connecting the respective fourth feature information of the plurality of sampling points in an order of the plurality of sampling points, a target feature vector of the initial three-dimensional bounding box; and obtaining, by correcting the initial three-dimensional bounding box according to the target feature vector of the initial three-dimensional bounding box, a corrected three-dimensional bounding box; and determining, according to a respective confidence score of each of the corrected one or more three-dimensional bounding boxes, the target three-dimensional bounding box from the corrected one or more three-dimensional bounding boxes.

In combination with any embodiment of the present disclosure, where determining, according to the second feature information of the key point in the at least one of second set ranges of the sampling point, the fourth feature information of the sampling point includes: for each of the second set ranges, determining, according to the second feature information of the key point in the second set range of the sampling point, respective initial fourth feature information of the sampling point corresponding to the second set range; and obtaining, by performing weighted averaging on the respective initial fourth feature information of the sampling point corresponding to the second set ranges, the fourth feature information of the sampling point.

In combination with any embodiment of the present disclosure, further including: obtaining the three-dimensional point cloud data in a scenario where an intelligent driving device is located; and controlling the intelligent driving device to drive according to the target three-dimensional object bounding box.

According to an aspect of the present disclosure, there is provided a device, comprising: at least one processor; and one or more memories coupled to the at least one processor and storing programming instructions for execution by the at least one processor to perform operations including: obtaining, by voxelizing three-dimensional point cloud data, voxelized point cloud data corresponding to a plurality of voxels; obtaining, by performing feature extraction on the voxelized point cloud data, respective first feature information of the plurality of voxels and one or more initial three-dimensional bounding boxes; for each of a plurality of key points obtained by sampling the three-dimensional point cloud data, determining, according to location information of the key point and the respective first feature information of the plurality of voxels, second feature information of the key point; and determining, according to the second feature information of the key point located in each of the one or more initial three-dimensional bounding boxes, a target three-dimensional bounding box from the one or more initial three-dimensional bounding boxes, wherein the target three-dimensional bounding box comprises a three-dimensional object to be detected.

In combination with any embodiment of the present disclosure, where obtaining, by performing feature extraction on the voxelized point cloud data, the respective first feature information of the plurality of voxels includes: performing a three-dimensional convolutional operation for the voxelized point cloud data with a pre-trained three-dimensional convolutional network, wherein the pre-trained three-dimensional convolutional network comprises a plurality of convolutional blocks connected sequentially and each of the plurality of convolutional blocks is configured to perform a corresponding three-dimensional convolutional operation for input data; obtaining a respective three-dimensional semantic feature volume output by each of the plurality of convolutional blocks, wherein each of the respective three-dimensional semantic feature volumes comprises a three-dimensional semantic feature of each of the plurality of voxels; and for each of the plurality of voxels, obtaining, according to the respective three-dimensional semantic feature volume output by each of the plurality of convolutional blocks, the first feature information of the voxel.

In combination with any embodiment of the present disclosure, where obtaining the one or more initial three-dimensional bounding boxes includes: obtaining third feature information of each pixel in a top-view feature map that is obtained by projecting, at a top-view angle, the respective three-dimensional semantic feature volume output by a last convolutional block in the pre-trained three-dimensional convolutional network; setting one or more three-dimensional anchor boxes with the each pixel as a center; for each of the one or more three-dimensional anchor boxes, determining, according to the third feature information of one or more pixels located on a border of the three-dimensional anchor box, a confidence score of the three-dimensional anchor box; and determining, according to the confidence score of each of the three-dimensional anchor boxes, the one or more initial three-dimensional bounding boxes from the one or more three-dimensional anchor boxes.

In combination with any embodiment of the present disclosure, where the plurality of convolutional blocks in the pre-trained three-dimensional convolutional network are configured to output three-dimensional semantic feature volumes of different scales, and where determining, according to the location information of the key point and the respective first feature information of the plurality of voxels, the second feature information of the key point includes: converting the respective three-dimensional semantic feature volume output by each of the plurality of convolutional blocks and the key point into a coordinate system; in the coordinate system, for each of the plurality of convolutional blocks, determining, according to the respective three-dimensional semantic feature volume output by the convolutional block, a three-dimensional semantic feature of a non-empty voxel of the key point in at least one of first set ranges, and determining, according to the three-dimensional semantic feature of the non-empty voxel, a first semantic feature vector of the key point in the convolutional block; obtaining, by sequentially connecting the first semantic feature vectors of the key point in the plurality of convolutional blocks, a second semantic feature vector of the key point; and taking the second semantic feature vector of the key point as the second feature information of the key point.

In combination with any embodiment of the present disclosure, where, for each of the plurality of convolutional blocks, determining, according to the respective three-dimensional semantic feature volume output by the convolutional block, the three-dimensional semantic feature of the non-empty voxel of the key point in the at least one of the first set ranges includes: determining, according to the respective three-dimensional semantic feature volume output by the convolutional block, the three-dimensional semantic feature of the non-empty voxel of the key point in each of the first set ranges, and where determining, according to the three-dimensional semantic feature of the non-empty voxel, the first semantic feature vector of the key point in the convolutional block includes: for each of the first set ranges, determining, according to the three-dimensional semantic feature of the non-empty voxel of the key point in the first set range, an initial first semantic feature vector of the key point corresponding to the first set range; and obtaining, by performing weighted averaging on the initial first semantic feature vectors of the key point corresponding to the first set ranges, the first semantic feature vector of the key point in the convolutional block.

In combination with any embodiment of the present disclosure, where the plurality of convolutional blocks in the pre-trained three-dimensional convolutional network are configured to output three-dimensional semantic feature volumes of different scales, and where determining, according to the location information of the key point and the respective first feature information of the plurality of voxels, the second feature information of the key point includes: converting the respective three-dimensional semantic feature volume output by each of the plurality of convolutional blocks and the key point into a coordinate system; in the coordinate system, for each of the plurality of convolutional blocks, determining, according to the respective three-dimensional semantic feature volume output by the convolutional block, a three-dimensional semantic feature of a non-empty voxel of the key point in a first set range, and determining, according to the three-dimensional semantic feature of the non-empty voxel, a first semantic feature vector of the key point in the convolutional block; obtaining, by sequentially connecting the first semantic feature vectors of the key point in the plurality of convolutional blocks, a second semantic feature vector of the key point; obtaining a point cloud feature vector of the key point in the three-dimensional point cloud data; obtaining, by projecting the key point to a top-view feature map, a top-view feature vector of the key point, wherein the top-view feature map is obtained by projecting the respective three-dimensional semantic feature volume output by a last convolutional block in the pre-trained three-dimensional convolutional network at a top-view angle; obtaining a target feature vector of the key point by connecting the second semantic feature vector, the point cloud feature vector, and the top-view feature vector of the key point; and determining the second feature information of the key point by one of: taking the target feature vector of the key point as the second feature information of the key point, or predicting a probability that the key point is a foreground point, multiplying the probability by the target feature vector of the key point to obtain a weighted feature vector of the key point, and taking the weighted feature vector of the key point as the second feature information of the key point.

In combination with any embodiment of the present disclosure, where obtaining the plurality of key points by sampling the three-dimensional point cloud data includes: obtaining the plurality of key points by sampling the three-dimensional point cloud data based on farthest point sampling.

In combination with any embodiment of the present disclosure, where determining, according to the second feature information of the key point located in each of the one or more initial three-dimensional bounding boxes, the target three-dimensional bounding box from the one or more initial three-dimensional bounding boxes includes: for each of the one or more initial three-dimensional bounding boxes, determining a plurality of sampling points according to grid points that are obtained by gridding the initial three-dimensional bounding box; for each of the plurality of sampling points, obtaining a corresponding key point in at least one of second set ranges of the sampling point, and determining respective fourth feature information of the sampling point according to the second feature information of the respective key point in the at least one of the second set ranges of the sampling point; obtaining, by sequentially connecting the respective fourth feature information of the plurality of sampling points in an order of the plurality of sampling points, a target feature vector of the initial three-dimensional bounding box; and obtaining, by correcting the initial three-dimensional bounding box according to the target feature vector of the initial three-dimensional bounding box, a corrected three-dimensional bounding box; and determining, according to a respective confidence score of each of the corrected one or more three-dimensional bounding boxes, the target three-dimensional bounding box from the corrected one or more three-dimensional bounding boxes.

According to an aspect of the present disclosure, there is provided a non-transitory computer readable storage medium coupled to at least one processor and having machine-executable instructions stored thereon that, when executed by the at least one processor, cause the at least one processor to perform operations including: obtaining, by voxelizing three-dimensional point cloud data, voxelized point cloud data corresponding to a plurality of voxels; obtaining, by performing feature extraction on the voxelized point cloud data, respective first feature information of the plurality of voxels and one or more initial three-dimensional bounding boxes; for each of a plurality of key points obtained by sampling the three-dimensional point cloud data, determining, according to location information of the key point and the respective first feature information of the plurality of voxels, second feature information of the key point; and determining, according to the second feature information of the key point located in each of the one or more initial three-dimensional bounding boxes, a target three-dimensional bounding box from the one or more initial three-dimensional bounding boxes, wherein the target three-dimensional bounding box comprises a three-dimensional object to be detected.

In the three-dimensional object detection method, apparatus and device and the storage medium according to one or more embodiments of the present disclosure, the first feature information of the voxel is obtained by performing feature extraction on the voxelized point cloud data, and one or more initial three-dimensional bounding boxes including a target object are obtained; a plurality of key points are obtained by sampling the three-dimensional point cloud data and the second feature information of the key points is also obtained, and the target three-dimensional bounding box can be determined from the one or more initial three-dimensional bounding boxes according to the second feature information of the key point located in each of the one or more initial three-dimensional bounding boxes. In the present disclosure, the whole three-dimensional scenario is represented by the key points obtained by sampling the three-dimensional point cloud data, and the target three-dimensional bounding box is determined by obtaining the second feature information of the key point. Compared with determining the three-dimensional object bounding box according to feature information of each piece of point cloud data in an original point cloud, the efficiency of three-dimensional object detection is improved. On the basis of the initial three-dimensional bounding box obtained according to the feature of the voxel, the target three-dimensional bounding box is determined from the initial three-dimensional bounding boxes according to the location information of the key point in the three-dimensional point cloud and the first feature information of the voxel, so that the target three-dimensional bounding box is determined from the initial three-dimensional bounding boxes by combining the feature of the voxel with the feature of the point cloud (i.e., location information of the key point), thereby utilizing the information of the point cloud more sufficiently. Therefore, the accuracy of the three-dimensional object detection may be improved.

### BRIEF DESCRIPTION OF THE DRAWINGS

FIG. 1 is a flowchart of a three-dimensional object detection method according to at least one embodiment of the present disclosure.

FIG. 2 is a schematic diagram of obtaining a key point according to at least one embodiment of the present disclosure.

FIG. 3 is a structural schematic diagram of a three-dimensional convolutional network according to at least one embodiment of the present disclosure.

FIG. 4 is a flowchart of a method of obtaining second feature information of a key point according to at least one embodiment of the present disclosure.

FIG. 5 is a schematic diagram of obtaining second feature information of a key point according to at least one embodiment of the present disclosure.

FIG. 6 is a flowchart of a method of determining a target three-dimensional bounding box from an initial three-dimensional bounding box according to at least one embodiment of the present disclosure.

FIG. 7 is a structural schematic diagram of a three-dimensional object detection apparatus according to at least one embodiment of the present disclosure.

FIG. 8 is a structural schematic diagram of a three-dimensional object detection device according to at least one embodiment of the present disclosure.

### DETAILED DESCRIPTION OF THE EMBODIMENTS

To help those skilled in the art to understand technical solutions in one or more embodiments of the present disclosure better, the technical solutions in one or more embodiments of the present disclosure will be described clearly and fully below in combination with the drawings in one or more embodiments of the present disclosure. Obviously, the described embodiments are merely some embodiments of the present disclosure rather than all embodiments. Other embodiments achieved by those of ordinary skill in the art based on one or more embodiments of the present disclosure without paying creative work shall all fall into the scope of protection of the present disclosure.

FIG. 1 is a flowchart of a three-dimensional object detection method according to at least one embodiment of the present disclosure. As shown in FIG. 1, the method includes steps 101 to 104.

At step 101, voxelized point cloud data corresponding to a plurality of voxels is obtained by voxelizing three-dimensional point cloud data.

A point cloud is a point set of surface features of a scenario or an object. Three-dimensional point cloud data may include location information of a point, for example, a three-dimensional coordinate, and may further include reflection intensity information. There may be a plurality of types of scenarios, such as a road scenario in automatic driving, a road scenario in robot navigation and an aviation scenario during flight of an aircraft.

In an embodiment of the present disclosure, the three-dimensional point cloud data of the scenario may be collected by an electronic device for performing the three-dimensional object detection method, or may be acquired from other devices, such as a lidar, a depth camera or other sensors, or may be obtained by searching in a network database.

Voxelizing the three-dimensional point cloud data refers to mapping the point cloud of the whole scenario to a three-dimensional voxel representation. For example, a space where the point cloud is located is equally divided into a plurality of voxels to represent a parameter of the point cloud in a unit of voxel. Each voxel may include one point in the point cloud, or include a plurality of points in the point cloud, or include no point in the point cloud. A voxel that includes at least one point may be referred to as a non-empty voxel; a voxel that does not include a point may be referred to as an empty voxel. For the voxelized point cloud data including a large number of empty voxels, a voxelization process may be referred to as sparse voxelization or sparse gridding, and a voxelization result may be referred to as sparsely voxelized point cloud data.

In an embodiment, the three-dimensional point cloud data may be voxelized in the following manner. The space corresponding to the three-dimensional point cloud data is divided into a plurality of equidistant voxels v, which is equivalent to split up points in the point cloud into the voxels v where the points are located. A size of the voxel v may be expressed as, for example, (vw, vl, vh), where vw, vl, and vh represent width, length and height of the voxel v respectively. A voxelized point cloud may be obtained by taking an average parameter of radar point clouds in each voxel v as the parameter of the voxel. A fixed number of radar points may be randomly sampled in each voxel v to reduce calculation and decrease imbalance of the radar points between voxels.

At step 102, respective first feature information of a plurality of voxels and one or more initial three-dimensional bounding boxes are obtained by performing feature extraction on the voxelized point cloud data.

In an embodiment of the present disclosure, the respective first feature information of a plurality of voxels may be obtained by performing feature extraction on the voxelized point cloud data with a pre-trained three-dimensional convolutional network. The first feature information is three-dimensional convolutional feature information.

In some embodiments, an initial three-dimensional bounding box including a target object, i.e., an initial detection result, may be obtained with a Region Proposal Network (RPN) based on features extracted from the voxelized point cloud data. The initial detection result includes positioning information and classification information of the initial three-dimensional bounding box.

Specific steps of performing feature extraction on the voxelized point cloud data with the pre-trained three-dimensional convolutional network and obtaining the initial three-dimensional bounding box with the RPN will be described in detail later.

At step 103, for each of a plurality of key points obtained by sampling the three-dimensional point cloud data, a second feature information of the key point is obtained according to location information of the key point and the respective first feature information of the plurality of voxels.

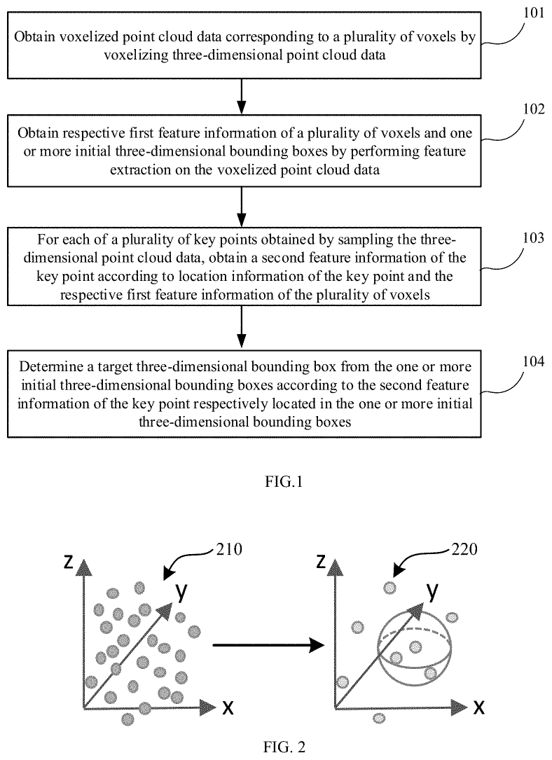

In an embodiment of the present disclosure, a plurality of key points may be obtained by sampling the three-dimensional point cloud data based on a Farthest Point Sampling (FPS) method. The method includes: assuming that a point cloud is C, a sampling point set is S, and S initially is an empty set; firstly, randomly selecting one point from the point cloud C and adding the point into the set S; next, searching for a point farthest from the set S in the set C-S (that is, a set after the points included in the sampling point set S are removed from the point cloud C), and adding the point into the set S; and then, continuing iteration until a desired number of points are selected. A plurality of key points obtained from the three-dimensional point cloud data by the FPS method are scattered in a three-dimensional space where the whole original point cloud is located and these key points are uniformly distributed around non-empty voxels, and can represent the whole scenario. As shown in FIG. 2, key point data 220 is obtained from raw three-dimensional point cloud data 210 by the FPS method.

The second feature information of the key point may be determined according to the location information of the plurality of key points in the original point cloud space and the first feature information of each voxel obtained at step 102. That is, three-dimensional feature information of an original scenario is encoded onto the plurality of key points, so that the second feature information of the plurality of key points can represent the three-dimensional feature information of the whole scenario.

At step 104, a target three-dimensional bounding box is determined from the one or more initial three-dimensional bounding boxes according to the second feature information of the key point respectively located in the one or more initial three-dimensional bounding boxes.

For the one or more initial three-dimensional bounding boxes including a target object at step 102, a confidence score of each initial three-dimensional bounding box may be obtained according to the second feature information of the key points included in the initial three-dimensional bounding box, so that the final target three-dimensional bounding box may be further screened out based on the confidence score.

In an embodiment of the present disclosure, the whole three-dimensional scenario is represented by the key points obtained by sampling the three-dimensional point cloud data, and the target three-dimensional bounding box is determined by obtaining the second feature information of the key points. Compared with determining the three-dimensional object bounding box according to the feature information of the original point cloud data, the efficiency of the three-dimensional object detection is improved. On the basis of the initial three-dimensional bounding box obtained according to the feature of the voxel, the target three-dimensional bounding box is determined from one or more initial three-dimensional bounding boxes based on the location information of the key point in the three-dimensional point cloud data and the first feature information of the voxel, and the target three-dimensional bounding box may be determined by combining the feature of the voxel with the feature of the point cloud (that is, location information of the key point). Compared with the direct determination of the three-dimensional bounding box according to the feature of the voxel, the information of the point cloud can be utilized more sufficiently, thereby improving the accuracy of three-dimensional object detection.

In some embodiments, the respective first feature information of a plurality of voxels may be obtained by performing feature extraction on the voxelized point cloud data based on the following method. The method includes: performing three-dimensional convolutional operation for the voxelized point cloud data with a pre-trained three-dimensional convolutional network, where the three-dimensional convolutional network includes a plurality of convolutional blocks that are connected sequentially and each convolutional block is configured to perform three-dimensional convolutional operation for input data; obtaining a three-dimensional semantic feature volume output by each convolutional block, where each three-dimensional semantic feature volume includes a three-dimensional semantic feature of each voxel; finally, for each of a plurality of voxels, obtaining the first feature information of the voxel according to the three-dimensional semantic feature volume output by each convolutional block. That is, the first feature information of each voxel may be determined by the three-dimensional semantic feature corresponding to each voxel.

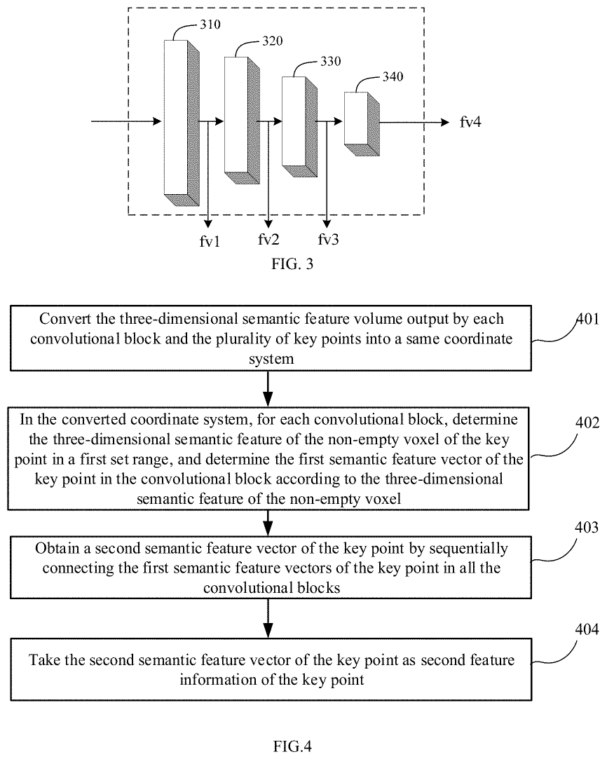

FIG. 3 is a structural schematic diagram of a three-dimensional convolutional network according to at least one embodiment of the present disclosure. As shown in FIG. 3, the three-dimensional convolutional network includes four convolutional blocks 310, 320, 330 and 340 that are connected sequentially; each convolutional block is configured to perform three-dimensional convolutional operation for input data and outputs a three-dimensional (3D) semantic feature volume. For example, the convolutional block 310 performs three-dimensional convolutional operation for the input voxelized point cloud data and outputs three-dimensional semantic feature volume fv1. The convolutional block 320 performs three-dimensional convolutional operation for three-dimensional semantic feature volume fv1 and outputs three-dimensional semantic feature volume fv2, and so on. The last convolutional block 340 outputs a three-dimensional semantic feature volume fv4 as an output result of the three-dimensional convolutional network. The three-dimensional semantic feature volume output by each convolutional block includes the three-dimensional semantic feature of each voxel, that is, the three-dimensional semantic feature volume is a feature vector set of a plurality of non-empty voxels.

Each convolutional block may include a plurality of convolutional layers, and different strides may be set for the last convolutional layer in each convolutional block, so that the three-dimensional semantic feature volume output by each convolutional block has a different scale. For example, the strides of the last convolutional layers in the four convolutional blocks 310, 320, 330 and 340 are set to 1, 2, 4 and 8 respectively to obtain the three-dimensional semantic feature volumes of one fold, two folds, four folds and eight folds by sequentially down-sampling the voxelized point cloud. The three-dimensional semantic feature volume output by each convolutional block may be used to determine a feature vector of a non-empty voxel. For example, for each non-empty voxel, the first feature information of the non-empty voxel may be jointly determined according to the three-dimensional semantic feature volumes of different scales output by the four convolutional blocks 310, 320, 330 and 340 respectively.

In some embodiments, the initial three-dimensional bounding box including a target object may be obtained with the RPN.

Firstly, third feature information of each pixel in a top-view feature map is obtained by projecting the three-dimensional semantic feature volume output by the last convolutional block in the three-dimensional convolutional network to the top-view feature map.

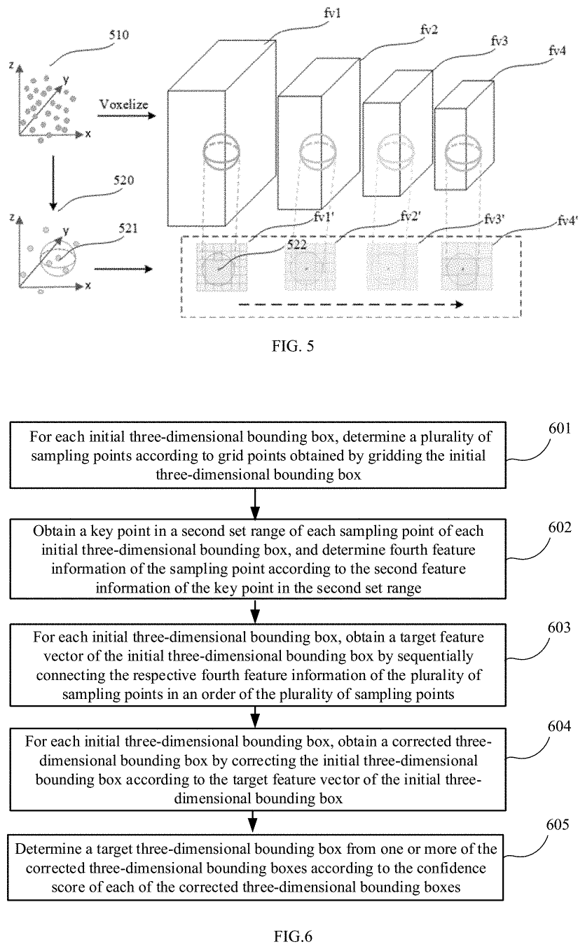

For the three-dimensional convolutional network shown in FIG. 3, an 8-fold down-sampled top-view (bird's-eye view) semantic feature map is obtained by projecting the 8-fold down-sampled three-dimensional semantic feature volume output by the convolutional block 340 at a top-view angle, and a third semantic feature of each pixel in the top-view semantic feature map may be obtained. The top-view semantic feature map may be obtained by projecting the 8-fold down-sampled three-dimensional semantic feature volume output by the convolutional block 340, for example, by stacking different voxels in a height direction (corresponding to a dotted line arrow direction shown in FIG. 5).

Next, one or more three-dimensional anchor boxes are set on each pixel of the top-view semantic feature map, that is, the three-dimensional anchor box is set with each pixel as center. The three-dimensional anchor box may be formed by two-dimensional anchor boxes on a plane of the top-view semantic feature map, and each point of the two-dimensional anchor box includes height information.

For each of the three-dimensional anchor boxes, a confidence score of each three-dimensional anchor box may be determined according to the third feature information of one or more pixels located on a border of the three-dimensional anchor box.

Finally, the initial three-dimensional bounding box including a target object (that is, including one or more pixels of the target object) may be determined from the one or more three-dimensional anchor boxes according to the confidence score of each three-dimensional anchor box; at the same time, a classification of the initial three-dimensional bounding box may be obtained, for example, the target object in the initial three-dimensional bounding box is a car, a pedestrian, and the like. In addition, location information of the initial three-dimensional bounding box may be obtained by correcting a location of the initial three-dimensional bounding box.

A process of determining the second feature information of the key point according to the location information of the key point and the first feature information of the voxel will be described in detail below.

In some embodiments, the respective second feature information of the plurality of key points may be obtained by encoding the three-dimensional semantic feature volumes of different scales to the plurality of key points according to the location information of the key point.

FIG. 4 is a flowchart of a method of obtaining second feature information of a key point according to at least one embodiment of the present disclosure. As shown in FIG. 4, the method includes steps 401 to 404.

At step 401, the three-dimensional semantic feature volume output by each convolutional block and the key point are converted into a same coordinate system.

FIG. 5 is a schematic diagram of obtaining second feature information of a key point according to an embodiment of the present disclosure. The voxelized point cloud data is obtained by voxelizing the point cloud 510; three-dimensional semantic feature volumes fv1, fv2, fv3 and fv4 are obtained by performing three-dimensional convolutional operation for the voxelized point cloud data; and the three-dimensional semantic feature volumes fv1, fv2, fv3 and fv4 and the key point cloud 520 are converted into a same coordinate system to obtain the converted three-dimensional semantic feature volumes fv1′, fv2′, fv3′ and fv4′ respectively, as shown in a dotted line box in FIG. 5. The key points are obtained from the original three-dimensional point cloud data 510 by the farthest point sampling method. Therefore, initial coordinates of the points in the key point cloud 520 are same as coordinates of the corresponding points in the original point cloud 510.

At step 402, in the converted coordinate system, for each convolutional block, the three-dimensional semantic feature volume of the non-empty voxel of the key point in a first set range is determined, and the first semantic feature vector of the key point in the convolutional block is determined according to the three-dimensional semantic feature of the non-empty voxel.

The three-dimensional semantic feature volume fv1 in FIG. 5 is taken as an example. The converted three-dimensional semantic feature volume fv1′ is obtained by converting the three-dimensional semantic feature volume fv1 and the key point cloud 520 into a same coordinate system. For each key point, the first set range may be determined according to a location of the each key point. The first set range may be spherical, that is, a spherical region is determined with the key point as a center of sphere, and the non-empty voxel surrounded by the spherical region is taken as a non-empty voxel of the key point in the first set range. For example, for a key point 521 in the key point cloud 520, a corresponding key point 522 is obtained after coordinate system conversion is performed. In this case, the non-empty voxel in a spherical set range with the key point 522 as a center of sphere as shown in FIG. 5 may be taken as a non-empty voxel of the key point 521 in the first set range.

The first semantic feature vector of the key point in the convolutional block 310 may be determined for the convolutional block 310 according to the three-dimensional semantic feature volumes of these non-empty voxels. For example, a unique feature vector of the key point in the convolutional block 310, i.e., the first semantic feature vector, may be obtained by performing maximum pooling operation for the three-dimensional semantic feature volume of the non-empty voxel of the key point in the first set range.

Those skilled in the art shall understand that a region of another shape may also be determined as the first set range of the key point, which is not limited in the embodiments of the present disclosure; a volume of the first set range may be set according to requirements, which is not limited in the embodiments of the present disclosure.

In some embodiments, a plurality of first set ranges may be set for each key point, and the three-dimensional semantic feature of the non-empty voxel of the key point in each first set range may be determined according to the three-dimensional semantic feature volume output by the convolutional block. Then, an initial first semantic feature vector of the key point corresponding to the first set range may be determined according to the three-dimensional semantic feature corresponding to the non-empty voxel of the key point in one first set range, and the first semantic feature vector of the key point in the convolutional block may be obtained by performing weighted averaging on the initial first semantic feature vectors of the key point corresponding to all first set ranges.

Contextual semantic information of the key point in different ranges is integrated by setting different first set ranges to extract more effective contextual semantic information, thereby improving the accuracy of target detection.

The first semantic feature vectors corresponding to the three-dimensional semantic feature volumes fv2, fv3 and fv4 may be obtained by a similar method, which will not be repeated herein.

At step 403, a second semantic feature vector of the key point is obtained by sequentially connecting the first semantic feature vectors of the key point in all the convolutional blocks.

The three-dimensional convolutional network shown in FIG. 3 is taken as an example. The first semantic feature vectors of the same key point in the convolutional blocks 310, 320, 330 and 340 are connected sequentially. Corresponding to FIG. 5, the second semantic feature vector of the key point is obtained by sequentially connecting the first semantic feature vectors determined after the three-dimensional semantic feature volumes fv1, fv2, fv3 and fv4 and the key point are converted into a same coordinate system.

At step 404, the second semantic feature vector of the key point is taken as second feature information of the key point.

In an embodiment of the present disclosure, semantic information obtained with the three-dimensional convolutional network is integrated in the second feature information of each key point. At the same time, the feature vector of the key point is obtained in a point-based manner in the first set range of the key point, that is, point cloud features are combined, thereby utilizing the information in the point cloud data more sufficiently. Thus, the second feature information of the key point is more accurate and more representative.

In some embodiments, the second feature information of the key point may also be obtained by the following method.

Firstly, the three-dimensional semantic feature volume output by each convolutional block and the key point are converted into a same coordinate system according to the above method; in the converted coordinate system, for each convolutional block, the three-dimensional semantic feature of the non-empty voxel of the key point in the first set range is determined according to the three-dimensional semantic feature volume output by the convolutional block, and the first semantic feature vector of the key point in the convolutional block is determined according to the three-dimensional semantic feature of the non-empty voxel; the second semantic feature vector of the key point is obtained by sequentially connecting the first semantic feature vectors of the key point in all convolutional blocks.

After the second semantic feature vector of the key point is obtained, a point cloud feature vector of the key point in the three-dimensional point cloud data is obtained.

In an embodiment, the point cloud feature vector of the key point may be determined by the following method: determining a spherical region with the key point as a center in a coordinate system corresponding to the original three-dimensional point cloud data, and obtaining feature vectors of a point cloud and the key point in the spherical region; and by performing fully-connected encoding for the feature vector of the point cloud and a three-dimensional coordinate of the key point in the spherical region and then performing maximum pooling, obtaining the point cloud feature vector of the key point. Those skilled in the art shall understand that the point cloud feature vector of the key point may also be obtained by other methods, which is not limited in the present disclosure.

Next, a top-view feature vector of the key point is obtained by projecting the key point to a top-view feature map.

In an embodiment of the present disclosure, the top-view feature map is obtained by projecting, at a top-view angle, the three-dimensional semantic feature volume output by the last convolutional block in the three-dimensional convolutional network.

The three-dimensional convolutional network shown in FIG. 3 is taken as an example. The top-view feature map is obtained by projecting an 8-fold down-sampled three-dimensional semantic feature volume output by the convolutional block 340 at the top-view angle.

In an embodiment, for each key point projected to the top-view feature map, the top-view feature vector of the key point projected may be determined by a bilinear interpolation method. Those skilled in the art shall understand that the top-view feature vector of the key point may also be obtained by other methods, which is not limited herein.

Next, a target feature vector of the key point is obtained by connecting the second semantic feature vector, the point cloud feature vector and the top-view feature vector of the key point, and the target feature vector of the key point is taken as the second feature information of the key point.

In an embodiment of the present disclosure, the second feature information of each key point combines both the location information of the key point in the three-dimensional point cloud data and the feature information of the key point in the top-view feature map in addition to integrating the semantic information, so that the second feature information of the key point is more accurate and more representative.

In some embodiments, the second feature information of the key point may also be obtained by the following method.

Firstly, the three-dimensional semantic feature volume output by each convolutional block and the key point are converted into a same coordinate system according to the above method; in the converted coordinate system, for each convolutional block, the three-dimensional semantic feature of the non-empty voxel of the key point in the first set range is determined according to the three-dimensional semantic feature volume output by the convolutional block, and the first semantic feature vector of the key point in the convolutional block is determined according to the three-dimensional semantic feature of the non-empty voxel; the second semantic feature vector of the key point is obtained by sequentially connecting the first semantic feature vectors of the key point in all convolutional blocks. After the second semantic feature vector of the key point is obtained, the point cloud feature vector of the key point in the three-dimensional point cloud data is obtained. Next, the top-view feature vector of the key point is obtained by projecting the key point into the top-view feature map. The target feature vector of the key point is obtained by connecting the second semantic feature vector, the point cloud feature vector and the top-view feature vector of the key point.

After the target feature vector of the key point is obtained, a probability that the key point is a foreground point is predicted, that is, a confidence level that the key point is a foreground point is predicted; a weighted feature vector of the key point is obtained by multiplying the probability that the key point is a foreground point by the target feature vector of the key point, and the weighted feature vector of the key point is taken as the second feature information of the key point.

In an embodiment of the present disclosure, the target feature vector of the key point is weighted by predicting the confidence level that the key point is a foreground point, so that the feature of the foreground key point is more prominent, thereby helping to improve the accuracy of the three-dimensional object detection.

After the second feature information of the key point is determined, a target three-dimensional bounding box may be determined according to the initial three-dimensional bounding box and the second feature information of the key point.

FIG. 6 is a flowchart of a method of determining a target three-dimensional bounding box according to at least one embodiment of the present disclosure. As shown in FIG. 6, the method includes steps 601 to 605.

At step 601, for each initial three-dimensional bounding box, a plurality of sampling points are determined according to grid points obtained by gridding the initial three-dimensional bounding box. The grid point refers to a vertex of a grid after gridding.

In an embodiment of the present disclosure, each initial three-dimensional bounding box may be gridded to obtain, for example, 6×6×6 sampling points.

At step 602, a key point in a second set range of each sampling point of each initial three-dimensional bounding box is obtained, and fourth feature information of the sampling point is determined according to the second feature information of the key point in the second set range.

In an embodiment, for each sampling point, by taking the sampling point as a center of a sphere, all key points in the sphere may be found according to a preset radius. After fully-connected encoding and maximum pooling are performed for the second semantic feature vectors of all key points in the sphere, the feature information of the sampling point is obtained and taken as fourth feature information of the sampling point.

In an embodiment, a plurality of second set ranges may be set for each sampling point, one piece of initial fourth feature information is determined according to the second feature information of the key point in one second set range of the sampling point, and the fourth feature information of the sampling point is obtained by performing weighted averaging for different pieces of initial fourth feature information of the sampling point. In this way, contextual semantic information of the sampling point in different local region scopes may be effectively extracted, and the fourth feature information of the sampling point is obtained by connecting the feature information of sampling point in different radius ranges. Therefore, the feature information of the sampling point is more effective, and helps to improve the accuracy of the three-dimensional object detection.

At step 603, for each initial three-dimensional bounding box, a target feature vector of the initial three-dimensional bounding box is obtained by sequentially connecting the respective fourth feature information of the plurality of sampling points in an order of the plurality of sampling points.

The target feature vector of the initial three-dimensional bounding box, i.e., the semantic feature of the initial three-dimensional bounding box, is obtained by sequentially connecting the fourth feature information of the sampling points corresponding to the initial three-dimensional bounding box.

At step 604, for each initial three-dimensional bounding box, a corrected three-dimensional bounding box is obtained by correcting the initial three-dimensional bounding box according to the target feature vector of the initial three-dimensional bounding box.

In an embodiment of the present disclosure, dimension reduction is performed for the target feature vector with a two-layer Multiple Layer Perceptron (MLP) network, and a confidence score of the initial three-dimensional bounding box may be determined through, for example, fully-connected processing, according to the dimension-reduced feature vector.

In addition, the corrected three-dimensional bounding box may be obtained by correcting location, size and direction of the initial three-dimensional bounding box according to the dimension-reduced feature vector. The location, size and direction of the corrected three-dimensional bounding box are more accurate than those of the initial three-dimensional bounding box.

At step 605, a target three-dimensional bounding box is determined from one or more of the corrected three-dimensional bounding boxes according to the confidence score of each of the corrected three-dimensional bounding boxes.

In an embodiment of the present disclosure, for the obtained corrected three-dimensional bounding boxes, a corrected three-dimensional bounding box with a confidence level greater than a set confidence threshold may be determined as the target three-dimensional bounding box. In this way, a desired target three-dimensional bounding box can be screened out from a plurality of corrected three-dimensional bounding boxes.

An embodiment of the present disclosure further provides an intelligent driving method. The method includes: obtaining three-dimensional point cloud data in a scenario where an intelligent driving device is located; performing three-dimensional object detection for the scenario to determine object bounding box according to the three-dimensional point cloud data by the three-dimensional object detection method according to any embodiment of the present disclosure; and controlling the intelligent driving device to drive according to the determined three-dimensional object bounding box.

The intelligent driving device includes an autonomous vehicle, a vehicle equipped with an Advanced Driving Assistant System (ADAS), a robot, and the like. For the autonomous vehicle or the robot, controlling the intelligent driving device to drive includes: controlling the intelligent driving device to accelerate, decelerate, steer, brake or keep a speed and a direction unchanged, or the like according to a detected three-dimensional object; for the vehicle equipped with the ADAS, controlling the intelligent driving device to drive includes: reminding a driver to control the vehicle to accelerate, decelerate, steer, brake or keep a speed and a direction unchanged, or the like according to a detected three-dimensional object and continuing monitoring a vehicle state to send an alarm or even take over the vehicle if necessary, in a case of determining that the vehicle state is different from a predicted state.

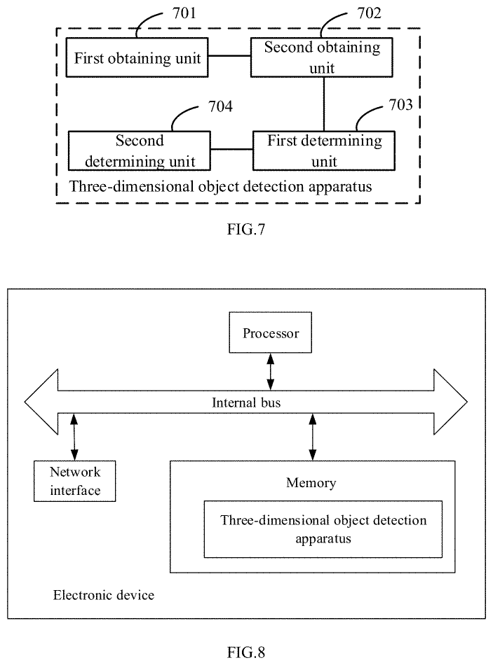

FIG. 7 is a structural schematic diagram of a three-dimensional object detection apparatus according to at least one embodiment of the present disclosure. As shown in FIG. 7, the apparatus includes: a first obtaining unit 701, configured to obtain voxelized point cloud data corresponding to a plurality of voxels by voxelizing three-dimensional point cloud data; a second obtaining unit 702, configured to obtain respective first feature information of the plurality of voxels and obtain one or more initial three-dimensional bounding boxes by performing feature extraction on the voxelized point cloud data; a first determining unit 703, configured to, for each of a plurality of key points obtained by sampling the three-dimensional point cloud data, determine second feature information of the key point according to location information of the key point and the respective first feature information of the plurality of voxels; and a second determining unit 704, configured to determine a target three-dimensional bounding box from the one or more initial three-dimensional bounding boxes according to the second feature information of the key point located in each of the one or more initial three-dimensional bounding boxes, where the target three-dimensional bounding box includes a three-dimensional object to be detected.

In some embodiments, when obtaining the first feature information corresponding to a plurality of voxels by performing feature extraction on the voxelized point cloud data, the second obtaining unit 702 is specifically configured to: perform three-dimensional convolutional operation for the voxelized point cloud data with a pre-trained three-dimensional convolutional network, where the three-dimensional convolutional network includes a plurality of convolutional blocks that are connected sequentially and each convolutional block is configured to perform three-dimensional convolutional operation for input data; obtain a three-dimensional semantic feature volume output by each convolutional block, where each three-dimensional semantic feature volume includes a three-dimensional semantic feature of each voxel; and obtain the first feature information of each of the plurality of voxels according to the three-dimensional semantic feature volume output by each convolutional block.

In some embodiments, when obtaining one or more initial three-dimensional bounding boxes, the second obtaining unit 702 is specifically configured to: obtain a top-view feature map by projecting the three-dimensional semantic feature volume output by the last convolutional block in the three-dimensional convolutional network at a top-view angle and obtain third feature information of each pixel in the top-view feature map; set one or more three-dimensional anchor boxes with each pixel as a center of three-dimensional anchor box; for each of three-dimensional anchor boxes, determine a confidence score of the three-dimensional anchor box according to the third feature information of one or more pixels located on a border of the three-dimensional anchor box; and determine one or more initial three-dimensional bounding boxes from the one or more three-dimensional anchor boxes according to the confidence score of each three-dimensional anchor box.

In some embodiments, when obtaining a plurality of key points by sampling the three-dimensional point cloud data, the first determining unit 703 is specifically configured to obtain the plurality of key points by sampling the three-dimensional point cloud data based on a farthest point sampling method.

In some embodiments, a plurality of convolutional blocks in the three-dimensional convolutional network are configured to output three-dimensional semantic feature volumes of different scales; when determining the second feature information of the key point according to the location information of the key point and the first feature information of the voxel, the first determining unit 703 is specifically configured to: convert the three-dimensional semantic feature volume output by each convolutional block and the key point into a same coordinate system; in the converted coordinate system, for each convolutional block, determine a three-dimensional semantic feature of a non-empty voxel of the key point in a first set range according to the three-dimensional semantic feature volume output by the convolutional block, and determine a first semantic feature vector of the key point in the convolutional block according to the three-dimensional semantic feature of the non-empty voxel; obtain a second semantic feature vector of the key point by sequentially connecting the first semantic feature vectors of the key point in all the convolutional blocks; and take the second semantic feature vector of the key point as second feature information of the key point.

In some embodiments, a plurality of convolutional blocks in the three-dimensional convolutional network are configured to output three-dimensional semantic feature volumes of different scales; when determining the second feature information of the key point according to the location information of the key point and the first feature information of the plurality of voxels, the first determining unit 703 is specifically configured to: convert the three-dimensional semantic feature volume output by each convolutional block and the key point into a same coordinate system; in the converted coordinate system, for each convolutional block, determine a three-dimensional semantic feature of a non-empty voxel of the key point in a first set range according to the three-dimensional semantic feature volume output by the convolutional block, and determine a first semantic feature vector of the key point in the convolutional block according to the three-dimensional semantic feature of the non-empty voxel; obtain a second semantic feature vector of the key point by sequentially connecting the first semantic feature vectors of the key point in all the convolutional blocks; obtain a point cloud feature vector of the key point in the three-dimensional point cloud data; obtain a top-view feature vector of the key point by projecting the key point to a top-view feature map, where the top-view feature map is obtained by projecting the three-dimensional semantic feature volume output by the last convolutional block in the three-dimensional convolutional network at a top-view angle; obtain a target feature vector of the key point by connecting the second semantic feature vector, the point cloud feature vector and the top-view feature vector of the key point; and take the target feature vector of the key point as the second feature information of the key point.

In some embodiments, a plurality of convolutional blocks in the three-dimensional convolutional network are configured to output three-dimensional semantic feature volumes of different scales; when determining the respective second feature information of the plurality of key points according to the location information of the plurality of key points and the first feature information of the plurality of voxels, the first determining unit 703 is specifically configured to: convert the three-dimensional semantic feature volume output by each convolutional block and the plurality of key points into a same coordinate system respectively; in the converted coordinate system, for each convolutional block, determine a three-dimensional semantic feature of a non-empty voxel of each key point in a first set range according to the three-dimensional semantic feature volume output by the convolutional block, and determine a first semantic feature vector of the key point according to the three-dimensional semantic feature of the non-empty voxel; obtain a second semantic feature vector of the key point by sequentially connecting the first semantic feature vectors of each key point in all the convolutional blocks; obtain a point cloud feature vector of the key point in the three-dimensional point cloud data; obtain a top-view feature vector of the key point by projecting the key point to a top-view feature map, where the top-view feature map is obtained by projecting the three-dimensional semantic feature volume output by the last convolutional block in the three-dimensional convolutional network at a top-view angle; obtain a target feature vector of the key point by connecting the second semantic feature vector, the point cloud feature vector and the top-view feature vector; predict a probability that the key point is a foreground point; obtain a weighted feature vector of the key point by multiplying the probability that the key point is a foreground point by the target feature vector of the key point; and take the weighted feature vector of the key point as the second feature information of the key point.

In some embodiments, there is a plurality of the first set ranges; when for each convolutional block, determining the three-dimensional semantic feature of the non-empty voxel of the key point in the first set range according to the three-dimensional semantic feature volume output by the convolutional block, the first determining unit 703 is specifically configured to: determine the three-dimensional semantic feature of the non-empty voxel of the key point in the first set range according to the three-dimensional semantic feature volume output by the convolutional block; determining the first semantic feature vector of the key point in the convolutional block according to the three-dimensional semantic feature of the non-empty voxel includes: for each of the first set ranges, determining an initial first semantic feature vector of the key point corresponding to the first set range according to the three-dimensional semantic feature of the non-empty voxel of the key point in the first set range; and obtaining the first semantic feature vector of the key point in the convolutional block by performing weighted averaging on the initial first semantic feature vectors of the key point corresponding to different first set ranges.

In some embodiments, the second determining unit 704 is specifically configured to: for each initial three-dimensional bounding box, determine a plurality of sampling points according to grid points obtained by gridding the initial three-dimensional bounding box; for each of the plurality of sampling points, obtain a key point in a second set range of the plurality of sampling point, and determine fourth feature information of the sampling point according to the second feature information of the key point in the second set range of the sampling point; obtain a target feature vector of the initial three-dimensional bounding box by sequentially connecting the respective fourth feature information of the plurality of sampling points in an order of the plurality of sampling points; obtain a corrected three-dimensional bounding box by correcting the initial three-dimensional bounding box according to the target feature vector of the initial three-dimensional bounding box; and determine a target three-dimensional bounding box from one or more of the corrected three-dimensional bounding boxes according to a confidence score of each of the corrected three-dimensional bounding boxes.

In some embodiments, there is a plurality of the second set ranges; when determining the fourth feature information of the sampling point according to the second feature information of the key point in the second set range of the sampling point, the second determining unit 704 is specifically configured to: for each of the second set ranges, determine initial fourth feature information of the sampling point corresponding to the second set range according to the second feature information of the key point in the second set range of the sampling point; and obtain the fourth feature information of the sampling point by performing weighted averaging on different initial fourth feature information of the sampling point corresponding to different second set ranges.

An embodiment of the present disclosure further provides an intelligent driving apparatus. The apparatus includes: an obtaining module, configured to obtain three-dimensional point cloud data in a scenario where an intelligent driving device is located; a detecting module, configured to perform three-dimensional object detection for the scenario according to the three-dimensional point cloud data by the three-dimensional object detection method according to any embodiment of the present disclosure; and a controlling module, configured to control the intelligent driving device to drive according to a determined three-dimensional object bounding box.

FIG. 8 is a structural schematic diagram of a three-dimensional object detection device according to at least one embodiment of the present disclosure. The device includes a processor and a memory for storing instructions executable by the processor. The instructions, when executed by the processor, cause the processor to implement the three-dimensional object detection method according to at least one embodiment of the present disclosure or perform the intelligent driving method according to an embodiment of the present disclosure.

The present disclosure further provides a computer readable storage medium storing computer programs. The computer programs, when executed by a processor, cause the processor to implement the three-dimensional object detection method according to at least one embodiment of the present disclosure or perform the intelligent driving method according to an embodiment of the present disclosure.

The present disclosure further provides a computer program including computer readable codes. The computer readable codes, when operated in an electronic device, cause a processor in the electronic device to perform the three-dimensional object detection method according to at least one embodiment of the present disclosure or perform the intelligent driving method according to an embodiment of the present disclosure.

Persons skilled in the art shall understand that one or more embodiments of the present disclosure may be provided as methods, systems, or computer program products. Thus, one or more embodiments of the present disclosure may be adopted in the form of entire hardware embodiments, entire software embodiments or embodiments combining software and hardware. Further, one or more embodiments of the present disclosure may be adopted in the form of computer program products that are implemented on one or more computer available storage media (including but not limited to magnetic disk memory, CD-ROM, and optical memory and so on) including computer available program codes.

Different embodiments in the present disclosure are all described in a progressive manner. Each embodiment focuses on the differences from other embodiments with those same or similar parts among the embodiments referred to each other. Particularly, since data processing device embodiments are basically similar to the method embodiments, the device embodiments are briefly described with relevant parts referred to the descriptions of the method embodiments.

Specific embodiments of the present disclosure are described above. Other embodiments not described herein still fall within the scope of the appended claims. In some cases, the actions or steps recorded in the claims may be performed in a sequence different from the embodiments to achieve a desired result. In addition, processes shown in drawings do not necessarily require a particular sequence or a continuous sequence to achieve the desired result. In some embodiments, a multi-task processing and parallel processing are possible or may also be advantageous.

The embodiments of the subject and functional operations described in the present disclosure may be achieved in the following: a digital electronic circuit, a tangible computer software or firmware, a computer hardware including a structure disclosed in the present disclosure or a structural equivalent thereof, or a combination of one or more of the above. The embodiment of the subject described in the present disclosure may be implemented as one or more computer programs, that is, one or more modules in computer program instructions encoded on a tangible non-transitory program carrier for being executed by or controlling a data processing apparatus. Alternatively or additionally, program instructions may be encoded on an artificially-generated transmission signal, such as a machine-generated electrical, optical or electromagnetic signal. The signal is generated to encode and transmit information to an appropriate receiver for execution by the data processing apparatus. The computer storage medium may be a machine readable storage device, a machine readable storage substrate, a random or serial access memory device, or a combination of one or more of the above.

The processing and logic flows described in the present disclosure may be executed by one or more programmable computers executing one or more computer programs to perform operations based on input data and generate outputs to perform corresponding functions. The processing and logic flows may be further executed by a dedicated logic circuit, such as a field programmable gate array (FPGA) or an application specific integrated circuit (ASIC), and the apparatus may be further implemented as the dedicated logic circuit.

Computers suitable for executing computer programs include, for example, a general-purpose and/or special-purpose microprocessor, or any other type of central processing unit. Generally, the central processing unit receives instructions and data from a read-only memory and/or random access memory. Basic components of a computer may include a central processing unit for implementing or executing instructions and one or more storage devices for storing instructions and data. Generally, the computer may further include one or more mass storage devices for storing data, such as magnetic disks, magneto-optical disks or optical disks, or the computer is operably coupled to this mass storage device to receive data therefrom or transmit data thereto, or both. However, the computer does not necessarily have such device. In addition, the computer may be embedded in another device, such as a mobile phone, a Personal Digital Assistant (PDA), a mobile audio or video player, a game console, a Global Positioning System (GPS) receiver, or a portable storage device, e.g., a Universal Serial Bus (USB) flash drive, and so on.

Computer readable media suitable for storing computer program instructions and data may include all forms of non-volatile memories, media and memory devices, such as semi-conductor memory devices (e.g., Erasable Programmable Read-Only Memory (EPROM), Electrically Erasable Programmable Read-Only Memory (EEPROM) and flash memory device), magnetic disks (e.g., internal hard disk or removable disk), magneto-optical disks, and CD ROM and DVD-ROM disks. The processor and the memory may be supplemented by or incorporated into a dedicated logic circuit.

Although many specific implementation details are included in the present disclosure, these details should not be construed as limiting any scope of the present disclosure or the claimed scope, but are mainly used to describe the features of specific embodiments of the present disclosure. Certain features described in several embodiments of the present disclosure may also be implemented in combination in a single embodiment. On the other hand, various features described in the single embodiment may also be implemented separately or in any appropriate sub-combination in several embodiments. In addition, although the features may function in certain combinations as described above and even be initially claimed as such, one or more features from the claimed combination may be removed from the combination in some cases, and the claimed combination may refer to a sub-combination or a variation of the sub-combination.

Similarly, although the operations are described in a specific order in the drawings, this should not be understood as requiring these operations to be performed in the shown specific order or in sequence, or requiring all of the illustrated operations to be performed, so as to achieve a desired result. In some cases, multi-task processing and parallel processing may be advantageous. In addition, the separation of different system modules and components in the above embodiments should not be understood as requiring such separation in all embodiments. Further, it is to be understood that the described program components and systems may be generally integrated together in a single software product or packaged into a plurality of software products.

Therefore, the specific embodiments of the subject are already described, and other embodiments are within the scope of the appended claims. In some cases, actions recorded in the claims may be performed in a different order to achieve the desired result. In addition, the processing described in the drawings is not necessarily performed in the shown specific order or in sequence, so as to achieve the desired result. In some implementations, multi-task processing and parallel processing may be advantageous.

The foregoing disclosure is merely illustrative of preferred embodiments of one or more embodiments of the present disclosure but not intended to limit one or more embodiments of the present disclosure, and any modifications, equivalent substitutions and improvements thereof made within the spirit and principles of one or more embodiments in the present disclosure shall be encompassed in the scope of protection of one or more embodiments in the present disclosure.

1. A computer-implemented method, comprising:
obtaining, by voxelizing three-dimensional point cloud data, voxelized point cloud data corresponding to a plurality of voxels;
obtaining, by performing feature extraction on the voxelized point cloud data, respective first feature information of the plurality of voxels and one or more initial three-dimensional bounding boxes;
for each of a plurality of key points obtained by sampling the three-dimensional point cloud data,
determining, according to location information of the key point and the respective first feature information of the plurality of voxels, second feature information of the key point; and
determining, according to the second feature information of the key point located in each of the one or more initial three-dimensional bounding boxes, a target three-dimensional bounding box from the one or more initial three-dimensional bounding boxes, wherein the target three-dimensional bounding box comprises a three-dimensional object to be detected.

2. The computer-implemented method according to claim 1, wherein obtaining, by performing feature extraction on the voxelized point cloud data, the respective first feature information of the plurality of voxels comprises:
performing a three-dimensional convolutional operation for the voxelized point cloud data with a pre-trained three-dimensional convolutional network, wherein the pre-trained three-dimensional convolutional network comprises a plurality of convolutional blocks connected sequentially and each of the plurality of convolutional blocks is configured to perform a corresponding three-dimensional convolutional operation for input data;
obtaining a respective three-dimensional semantic feature volume output by each of the plurality of convolutional blocks, wherein each of the respective three-dimensional semantic feature volumes comprises a three-dimensional semantic feature of each of the plurality of voxels; and
for each of the plurality of voxels, obtaining, according to the respective three-dimensional semantic feature volume output by each of the plurality of convolutional blocks, the first feature information of the voxel.

3. The computer-implemented method according to claim 2, wherein obtaining the one or more initial three-dimensional bounding boxes comprises:
obtaining third feature information of each pixel in a top-view feature map that is obtained by projecting, at a top-view angle, the respective three-dimensional semantic feature volume output by a last convolutional block in the pre-trained three-dimensional convolutional network;
setting one or more three-dimensional anchor boxes with the each pixel as a center;
for each of the one or more three-dimensional anchor boxes, determining, according to the third feature information of one or more pixels located on a border of the three-dimensional anchor box, a confidence score of the three-dimensional anchor box; and
determining, according to the confidence score of each of the three-dimensional anchor boxes, the one or more initial three-dimensional bounding boxes from the one or more three-dimensional anchor boxes.

4. The computer-implemented method according to claim 2, wherein the plurality of convolutional blocks in the pre-trained three-dimensional convolutional network are configured to output three-dimensional semantic feature volumes of different scales, and
wherein determining, according to the location information of the key point and the respective first feature information of the plurality of voxels, the second feature information of the key point comprises:
converting the respective three-dimensional semantic feature volume output by each of the plurality of convolutional blocks and the key point into a coordinate system;
in the coordinate system, for each of the plurality of convolutional blocks,
determining, according to the respective three-dimensional semantic feature volume output by the convolutional block, a three-dimensional semantic feature of a non-empty voxel of the key point in at least one of first set ranges, and
determining, according to the three-dimensional semantic feature of the non-empty voxel, a first semantic feature vector of the key point in the convolutional block;
obtaining, by sequentially connecting the first semantic feature vectors of the key point in the plurality of convolutional blocks, a second semantic feature vector of the key point; and
taking the second semantic feature vector of the key point as the second feature information of the key point.

5. The computer-implemented method according to claim 4, wherein, for each of the plurality of convolutional blocks, determining, according to the respective three-dimensional semantic feature volume output by the convolutional block, the three-dimensional semantic feature of the non-empty voxel of the key point in the at least one of the first set ranges comprises:
determining, according to the respective three-dimensional semantic feature volume output by the convolutional block, the three-dimensional semantic feature of the non-empty voxel of the key point in each of the first set ranges, and
wherein determining, according to the three-dimensional semantic feature of the non-empty voxel, the first semantic feature vector of the key point in the convolutional block comprises:
for each of the first set ranges, determining, according to the three-dimensional semantic feature of the non-empty voxel of the key point in the first set range, an initial first semantic feature vector of the key point corresponding to the first set range; and
obtaining, by performing weighted averaging on the initial first semantic feature vectors of the key point corresponding to the first set ranges, the first semantic feature vector of the key point in the convolutional block.

6. The computer-implemented method according to claim 2, wherein the plurality of convolutional blocks in the pre-trained three-dimensional convolutional network are configured to output three-dimensional semantic feature volumes of different scales, and
wherein determining, according to the location information of the key point and the respective first feature information of the plurality of voxels, the second feature information of the key point comprises:
converting the respective three-dimensional semantic feature volume output by each of the plurality of convolutional blocks and the key point into a coordinate system;
in the coordinate system, for each of the plurality of convolutional blocks,
determining, according to the respective three-dimensional semantic feature volume output by the convolutional block, a three-dimensional semantic feature of a non-empty voxel of the key point in a first set range, and
determining, according to the three-dimensional semantic feature of the non-empty voxel, a first semantic feature vector of the key point in the convolutional block;
obtaining, by sequentially connecting the first semantic feature vectors of the key point in the plurality of convolutional blocks, a second semantic feature vector of the key point;
obtaining a point cloud feature vector of the key point in the three-dimensional point cloud data;
obtaining, by projecting the key point to a top-view feature map, a top-view feature vector of the key point, wherein the top-view feature map is obtained by projecting the respective three-dimensional semantic feature volume output by a last convolutional block in the pre-trained three-dimensional convolutional network at a top-view angle;
obtaining a target feature vector of the key point by connecting the second semantic feature vector, the point cloud feature vector, and the top-view feature vector of the key point; and
taking the target feature vector of the key point as the second feature information of the key point.

7. The computer-implemented method according to claim 2, wherein the plurality of convolutional blocks in the pre-trained three-dimensional convolutional network are configured to output three-dimensional semantic feature volumes of different scales, and
wherein determining, according to the location information of the key point and the respective first feature information of the plurality of voxels, the second feature information of the key point comprises:
converting the respective three-dimensional semantic feature volume output by each of the plurality of convolutional blocks and the key point into a coordinate system;
in the coordinate system, for each of the plurality of convolutional blocks,
determining, according to the three-dimensional semantic feature volume output by the convolutional block, a three-dimensional semantic feature of a non-empty voxel of the key point in a first set range, and
determining, according to the three-dimensional semantic feature of the non-empty voxel, a first semantic feature vector of the key point in the convolutional block;
obtaining, by sequentially connecting the first semantic feature vectors of the key point in the plurality of convolutional blocks, a second semantic feature vector of the key point;
obtaining a point cloud feature vector of the key point in the three-dimensional point cloud data;
obtaining, by projecting the key point to a top-view feature map, a top-view feature vector of the key point, wherein the top-view feature map is obtained by projecting the respective three-dimensional semantic feature volume output by a last convolutional block in the three-dimensional convolutional network at a top-view angle;
obtaining a target feature vector of the key point by connecting the second semantic feature vector, the point cloud feature vector, and the top-view feature vector of the key point;
predicting a probability that the key point is a foreground point;
obtaining, by multiplying the probability that the key point is a foreground point by the target feature vector of the key point, a weighted feature vector of the key point; and
taking the weighted feature vector of the key point as the second feature information of the key point.

8. The computer-implemented method according to claim 1, wherein obtaining the plurality of key points by sampling the three-dimensional point cloud data comprises:
obtaining the plurality of key points by sampling the three-dimensional point cloud data based on farthest point sampling.

9. The computer-implemented method according to claim 1, wherein determining, according to the second feature information of the key point located in each of the one or more initial three-dimensional bounding boxes, the target three-dimensional bounding box from the one or more initial three-dimensional bounding boxes comprises:
for each of the one or more initial three-dimensional bounding boxes,
determining a plurality of sampling points according to grid points that are obtained by gridding the initial three-dimensional bounding box;
for each of the plurality of sampling points,
obtaining a corresponding key point in at least one of second set ranges of the sampling point, and
determining respective fourth feature information of the sampling point according to the second feature information of the respective key point in the at least one of the second set ranges of the sampling point;
obtaining, by sequentially connecting the respective fourth feature information of the plurality of sampling points in an order of the plurality of sampling points, a target feature vector of the initial three-dimensional bounding box; and
obtaining, by correcting the initial three-dimensional bounding box according to the target feature vector of the initial three-dimensional bounding box, a corrected three-dimensional bounding box; and
determining, according to a respective confidence score of each of the corrected one or more three-dimensional bounding boxes, the target three-dimensional bounding box from the corrected one or more three-dimensional bounding boxes.

10. The computer-implemented method according to claim 9, wherein determining, according to the second feature information of the key point in the at least one of second set ranges of the sampling point, the fourth feature information of the sampling point comprises:
for each of the second set ranges, determining, according to the second feature information of the key point in the second set range of the sampling point, respective initial fourth feature information of the sampling point corresponding to the second set range; and
obtaining, by performing weighted averaging on the respective initial fourth feature information of the sampling point corresponding to the second set ranges, the fourth feature information of the sampling point.

11. The computer-implemented method according to claim 1, further comprising:
obtaining the three-dimensional point cloud data in a scenario where an intelligent driving device is located; and
controlling the intelligent driving device to drive according to the target three-dimensional object bounding box.

12. A device, comprising:
at least one processor; and
one or more memories coupled to the at least one processor and storing programming instructions for execution by the at least one processor to perform operations comprising
obtaining, by voxelizing three-dimensional point cloud data, voxelized point cloud data corresponding to a plurality of voxels;
obtaining, by performing feature extraction on the voxelized point cloud data, respective first feature information of the plurality of voxels and one or more initial three-dimensional bounding boxes;
for each of a plurality of key points obtained by sampling the three-dimensional point cloud data,
determining, according to location information of the key point and the respective first feature information of the plurality of voxels, second feature information of the key point; and
determining, according to the second feature information of the key point located in each of the one or more initial three-dimensional bounding boxes, a target three-dimensional bounding box from the one or more initial three-dimensional bounding boxes, wherein the target three-dimensional bounding box comprises a three-dimensional object to be detected.

13. The device according to claim 12, wherein obtaining, by performing feature extraction on the voxelized point cloud data, the respective first feature information of the plurality of voxels comprises:
performing a three-dimensional convolutional operation for the voxelized point cloud data with a pre-trained three-dimensional convolutional network, wherein the pre-trained three-dimensional convolutional network comprises a plurality of convolutional blocks connected sequentially and each of the plurality of convolutional blocks is configured to perform a corresponding three-dimensional convolutional operation for input data;
obtaining a respective three-dimensional semantic feature volume output by each of the plurality of convolutional blocks, wherein each of the respective three-dimensional semantic feature volumes comprises a three-dimensional semantic feature of each of the plurality of voxels; and
for each of the plurality of voxels, obtaining, according to the respective three-dimensional semantic feature volume output by each of the plurality of convolutional blocks, the first feature information of the voxel.

14. The device according to claim 13, wherein obtaining the one or more initial three-dimensional bounding boxes comprises:
obtaining third feature information of each pixel in a top-view feature map that is obtained by projecting, at a top-view angle, the respective three-dimensional semantic feature volume output by a last convolutional block in the pre-trained three-dimensional convolutional network;
setting one or more three-dimensional anchor boxes with the each pixel as a center;
for each of the one or more three-dimensional anchor boxes, determining, according to the third feature information of one or more pixels located on a border of the three-dimensional anchor box, a confidence score of the three-dimensional anchor box; and
determining, according to the confidence score of each of the three-dimensional anchor boxes, the one or more initial three-dimensional bounding boxes from the one or more three-dimensional anchor boxes.

15. The device according to claim 13, wherein the plurality of convolutional blocks in the pre-trained three-dimensional convolutional network are configured to output three-dimensional semantic feature volumes of different scales, and
wherein determining, according to the location information of the key point and the respective first feature information of the plurality of voxels, the second feature information of the key point comprises:
converting the respective three-dimensional semantic feature volume output by each of the plurality of convolutional blocks and the key point into a coordinate system;
in the coordinate system, for each of the plurality of convolutional blocks,
determining, according to the respective three-dimensional semantic feature volume output by the convolutional block, a three-dimensional semantic feature of a non-empty voxel of the key point in at least one of first set ranges, and
determining, according to the three-dimensional semantic feature of the non-empty voxel, a first semantic feature vector of the key point in the convolutional block;
obtaining, by sequentially connecting the first semantic feature vectors of the key point in the plurality of convolutional blocks, a second semantic feature vector of the key point; and
taking the second semantic feature vector of the key point as the second feature information of the key point.

16. The device according to claim 15, wherein, for each of the plurality of convolutional blocks, determining, according to the respective three-dimensional semantic feature volume output by the convolutional block, the three-dimensional semantic feature of the non-empty voxel of the key point in the at least one of the first set ranges comprises:
determining, according to the respective three-dimensional semantic feature volume output by the convolutional block, the three-dimensional semantic feature of the non-empty voxel of the key point in each of the first set ranges, and
wherein determining, according to the three-dimensional semantic feature of the non-empty voxel, the first semantic feature vector of the key point in the convolutional block comprises:
for each of the first set ranges, determining, according to the three-dimensional semantic feature of the non-empty voxel of the key point in the first set range, an initial first semantic feature vector of the key point corresponding to the first set range; and
obtaining, by performing weighted averaging on the initial first semantic feature vectors of the key point corresponding to the first set ranges, the first semantic feature vector of the key point in the convolutional block.

17. The device according to claim 13, wherein the plurality of convolutional blocks in the pre-trained three-dimensional convolutional network are configured to output three-dimensional semantic feature volumes of different scales, and
wherein determining, according to the location information of the key point and the respective first feature information of the plurality of voxels, the second feature information of the key point comprises:
converting the respective three-dimensional semantic feature volume output by each of the plurality of convolutional blocks and the key point into a coordinate system;
in the coordinate system, for each of the plurality of convolutional blocks,
determining, according to the respective three-dimensional semantic feature volume output by the convolutional block, a three-dimensional semantic feature of a non-empty voxel of the key point in a first set range, and
determining, according to the three-dimensional semantic feature of the non-empty voxel, a first semantic feature vector of the key point in the convolutional block;
obtaining, by sequentially connecting the first semantic feature vectors of the key point in the plurality of convolutional blocks, a second semantic feature vector of the key point;
obtaining a point cloud feature vector of the key point in the three-dimensional point cloud data;
obtaining, by projecting the key point to a top-view feature map, a top-view feature vector of the key point, wherein the top-view feature map is obtained by projecting the respective three-dimensional semantic feature volume output by a last convolutional block in the pre-trained three-dimensional convolutional network at a top-view angle;
obtaining a target feature vector of the key point by connecting the second semantic feature vector, the point cloud feature vector, and the top-view feature vector of the key point; and
determining the second feature information of the key point by one of:
taking the target feature vector of the key point as the second feature information of the key point, or
predicting a probability that the key point is a foreground point, multiplying the probability by the target feature vector of the key point to obtain a weighted feature vector of the key point, and taking the weighted feature vector of the key point as the second feature information of the key point.

18. The device according to claim 12, wherein obtaining the plurality of key points by sampling the three-dimensional point cloud data comprises:
obtaining the plurality of key points by sampling the three-dimensional point cloud data based on farthest point sampling.

19. The device according to claim 12, wherein determining, according to the second feature information of the key point located in each of the one or more initial three-dimensional bounding boxes, the target three-dimensional bounding box from the one or more initial three-dimensional bounding boxes comprises:
for each of the one or more initial three-dimensional bounding boxes,
determining a plurality of sampling points according to grid points that are obtained by gridding the initial three-dimensional bounding box;
for each of the plurality of sampling points,
obtaining a corresponding key point in at least one of second set ranges of the sampling point, and
determining respective fourth feature information of the sampling point according to the second feature information of the respective key point in the at least one of the second set ranges of the sampling point;
obtaining, by sequentially connecting the respective fourth feature information of the plurality of sampling points in an order of the plurality of sampling points, a target feature vector of the initial three-dimensional bounding box; and
obtaining, by correcting the initial three-dimensional bounding box according to the target feature vector of the initial three-dimensional bounding box, a corrected three-dimensional bounding box; and
determining, according to a respective confidence score of each of the corrected one or more three-dimensional bounding boxes, the target three-dimensional bounding box from the corrected one or more three-dimensional bounding boxes.

20. A non-transitory computer readable storage medium coupled to at least one processor and having machine-executable instructions stored thereon that, when executed by the at least one processor, cause the at least one processor to perform operations comprising:
obtaining, by voxelizing three-dimensional point cloud data, voxelized point cloud data corresponding to a plurality of voxels;
obtaining, by performing feature extraction on the voxelized point cloud data, respective first feature information of the plurality of voxels and one or more initial three-dimensional bounding boxes;
for each of a plurality of key points obtained by sampling the three-dimensional point cloud data,
determining, according to location information of the key point and the respective first feature information of the plurality of voxels, second feature information of the key point; and
determining, according to the second feature information of the key point located in each of the one or more initial three-dimensional bounding boxes, a target three-dimensional bounding box from the one or more initial three-dimensional bounding boxes, wherein the target three-dimensional bounding box comprises a three-dimensional object to be detected.
